(19) United States
(12) Patent Application Publication
(10) Pub. No.: US 2010/0253845 A1
(43) Pub. Date: Oct. 7, 2010

(54) IMAGE PROCESSING METHOD AND IMAGE PROCESSING APPARATUS

(75) Inventor: Takeshi KUBOTA, Kawasaki (JP)

Correspondence Address: SUGHRUE MION, PLLC, 2100 PENNSYLVANIA AVENUE, N.W., SUITE 800, WASHINGTON, DC, 20037, US

(73) Assignee: NEC ELECTRONICS CORPORATION, Kawasaki (JP)

(21) Appl. No.: 12/754,286

(22) Filed: Apr. 5, 2010

(30) Foreign Application Priority Data
Apr. 6, 2009 (JP) 2009-091938

(51) Int. Cl. H04N 9/64

(52) U.S. Cl. 348/571; 348/E09.037

(57) ABSTRACT

An image processing method prepares image data having luminance information (Y) and chrominance information (UN) including first chrominance information (U) being information of a color difference between a blue component and luminance and second chrominance information (V) being information of a color difference between a red component and the luminance. The method then outputs the luminance information and the chrominance information in the image data forming a first frame as data forming the first frame, and further outputs the luminance information in the image data forming a second frame subsequent to the first frame and the chrominance information in the image data forming the first frame as data forming the second frame.

### INCORPORATION BY REFERENCE

This application is based upon and claims the benefit of priority from Japanese patent application No. 2009-091938, filed on Apr. 6, 2009, the disclosure of which is incorporated herein in its entirety by reference.

### BACKGROUND

1. Field of the Invention

The present invention relates to an image processing method and an image processing apparatus, and, particularly, to an image processing method and an image processing apparatus that compress image data represented in YUV.

2. Description of Related Art

Recently, in order to reduce the effect of an afterimage phenomenon that occurs when displaying a picture with a large motion, processing that increases the number of frames in a received picture has been performed in a device, particularly in a TV device using a liquid crystal panel. Such processing enables display with a high frame rate such as 60 frames or 120 frames per second, for example, in a liquid crystal panel.

In still images that are displayed successively to make a video, an every pixel has information such as color and brightness. There are broadly two ways to represent the information. One is to form one pixel with luminance (brightness) information and two kinds of color (chrominance) information as shown in FIG. 6, which is generally called YUV format, YCbCr or YPbPr (cf. Japanese Unexamined Patent Application Publication No. 10-304401). The other one is to form a pixel with the three primary colors (red, blue and green) instead of the luminance and chrominance, which is generally called RGB format.

The YUV format shown in FIG. 6 is a format in which one pixel has a luminance component (Y), a chrominance 1 (U) represented as a color difference between a luminance component and a blue component, and a chrominance 2 (V) represented as a color difference between the luminance component and a red component independently of one another, which is called YUV 4:4:4 or the like. YUV 4:4:4 is such that an image is the finest but a data size is large.

A second format is YUV 4:2:2. In this format, Y in two pixels arranged side by side have U and V in common as shown in FIG. 7. If information of one frame is represented by YUV 4:2:2, the amount of information of U and V are ½ of the amount of information of Y as shown in FIG. 7. Thus, the total amount of data can be reduced to ⅔ by sharing the chrominance information in adjacent pixels. In this format, the amount of data in one frame is reduced by utilizing the characteristic that the human eye has a lower resolution for color than for brightness.

A third format is YUV 4:2:0. In this format, Y in four pixels arranged two pixels by two pixels have U and V in common as shown in FIG. 8. If information of one frame is represented by YUV 4:2:0, the amount of information of U and V are ¼ of the amount of information of Y as shown in FIG. 8. Thus, the total amount of data can be reduced to ½ by sharing the chrominance information of four pixels arranged two pixels by two pixels. Japanese analog TV broadcast (NTSC) broadcasts a picture in YUV 4:4:2 at 30 frames per second. Further, digital TV broadcast broadcasts picture data that is compressed by an operation using picture compression technology such as MPEG, and the picture data is decompressed in a receiving device after reception. The decompressed picture is a picture at 30 frames per second, each frame having the above-described YUV data (typically in format of YUV 4:2:2 or YUV 4:2:0).

The received picture data is processed by a driver LSI or the like and then displayed on a display device (a cathode ray tube, a liquid crystal panel etc.). Recently, particularly in a TV device using a liquid crystal panel, processing that increases the number of frames of a received picture has been performed in the device in order to reduce the effect of an afterimage phenomenon that occurs when displaying a picture with a large motion. Such processing enables display of a video with a high frame rate such as 60 frames or 120 frames per second, for example.

### SUMMARY

In the digital TV device described in the related art, processing that increases the number of frames of a received picture is performed in the device in order to reduce the effect of an afterimage phenomenon that occurs when displaying a picture with a large motion. If the number of frames increases, the amount of data handled in the device becomes larger, leading to an increase in memory size, transmission channel band, power consumption and so on.

Further, the time allocated for frame generation processing or data transfer is limited to within a time period to display one frame. Therefore, if the number of frames increases, the display time is shortened accordingly, and it is thus necessary to increase the speed of frame generation processing and data transfer. This raises a need to increase the clock frequency and perform data processing in parallel. However, such a circuit configuration causes an increase in circuit scale and power consumption.

Furthermore, for high-speed transmission, it is necessary to use a new transmission technique such as changing from transmission by CMOS signals to transmission using differential signaling such as LVDS or placing a plurality of LVDS transmission channels in parallel. However, because it is necessary to fabricate a new LSI or the like in order to implement such a technique, development costs increase, and product costs also increase due to an increase in device.

A first exemplary aspect of the present invention is an image processing method which includes preparing image data having luminance information and chrominance information including first chrominance information being information of a color difference between a blue component and luminance and second chrominance information being information of a color difference between a red component and the luminance, outputting the luminance information and the chrominance information in the image data forming a first frame as data forming the first frame, and outputting the luminance information in the image data forming a second frame subsequent to the first frame and the chrominance information in the image data forming the first frame as data forming the second frame.

Because the image processing method according to the first exemplary aspect of the present invention uses the chrominance information of the first frame when displaying the second frame, it is possible to reduce the size of the image data.

A second exemplary aspect of the present invention is an image processing apparatus which includes a chrominance information separating unit that separates chrominance information from image data in a first frame having luminance information and chrominance information including first chrominance information being information of a color difference between a blue component and luminance and second chrominance information being information of a color difference between a red component and the luminance, a storage unit that stores the chrominance information of the first frame separated by the chrominance information separating unit, and a luminance and chrominance combining unit that combines luminance information of a second frame and the chrominance information of the first frame stored in the storage unit.

Because the image processing apparatus according to the second exemplary aspect of the present invention uses the chrominance information of the first frame when displaying the second frame, it is possible to reduce the size of the image data.

According to the exemplary aspects of the present invention described above, it is possible to provide an image processing method and an image processing apparatus that suppress an increase in the size of image data in spite of an increase in the number of frames.

### BRIEF DESCRIPTION OF THE DRAWINGS

The above and other exemplary aspects, advantages and features will be more apparent from the following description of certain exemplary embodiments taken in conjunction with the accompanying drawings, in which:

FIG. 1 is a block diagram showing an image processing apparatus according to a first exemplary embodiment;

FIG. 2 is a view to describe an image processing method according to the first exemplary embodiment;

FIG. 3 is a view to describe an image processing method according to a second exemplary embodiment;

FIG. 4 is a view to describe an image processing method according to a third exemplary embodiment;

FIG. 5 is a view to describe an image processing method according to a fourth exemplary embodiment;

FIG. 6 is a view showing an image represented in YUV 4:4:4;

FIG. 7 is a view showing an image represented in YUV 4:2:2; and

FIG. 8 is a view showing an image represented in YUV 4:2:0.

### DETAILED DESCRIPTION OF THE EXEMPLARY EMBODIMENTS

### First Exemplary Embodiment

An exemplary embodiment of the present invention is described hereinafter with reference to the drawings.

An image processing method according to an exemplary embodiment prepares image data having luminance information (Y) and chrominance information (UN) including first chrominance information (U) that is information of a color difference between a blue component and the luminance and second chrominance information (V) that is information of a color difference between a red component and the luminance.

Then, the luminance information (Y) and the chrominance information (U/V) forming a first frame of the image data are output as data forming the first frame.

Further, the luminance information (Y) forming a second frame subsequent to the first frame of the image data and the chrominance information (U/V) forming the first frame of the image data are output as data forming the second frame.

Because the image processing method according to the exemplary embodiment uses the chrominance information of the first frame when displaying the second frame, it is possible to reduce the size of the image data. This is specifically described hereinafter.

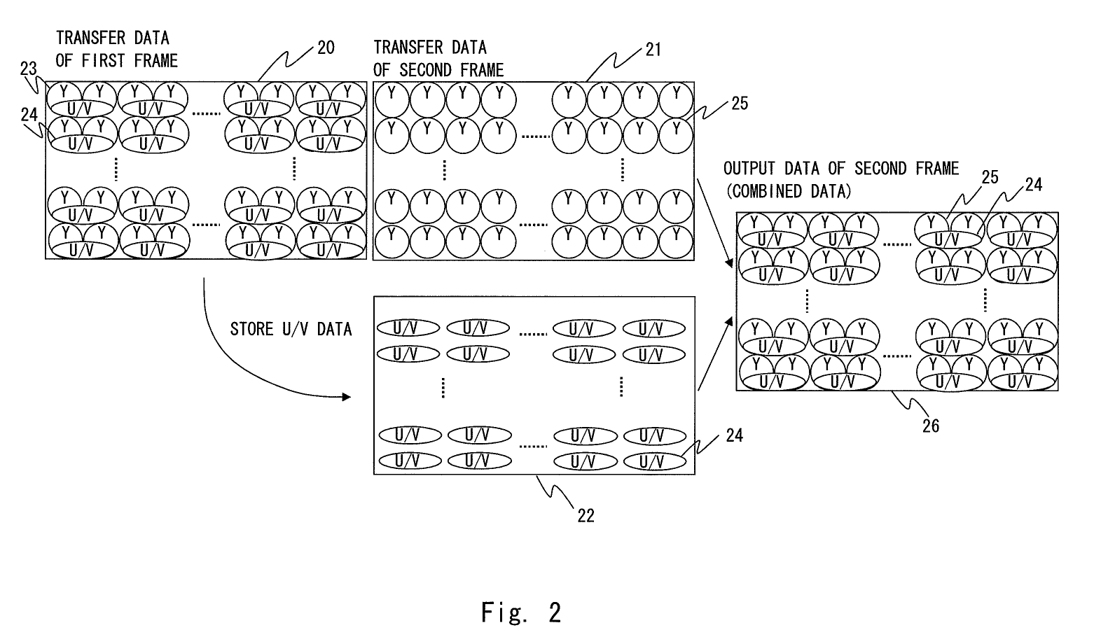

FIG. 2 is a view to describe an image processing method according to the exemplary embodiment. FIG. 2 shows an example of a case where a frame of an input picture is represented in YUV 4:2:2. Transfer data (image data) 20 of the first frame is made up of luminance information (Y) 23, the first chrominance information (U) that is information of a color difference between a blue component and luminance and the second chrominance information (V) that is information of a color difference between a red component and the luminance. The first chrominance information (U) and the second chrominance information (V) are collectively referred to as chrominance information (UN) 24. The first frame is in YUV 4:2:2 format in which each pixel has luminance information (Y) 23 and two pixels adjacent side by side have chrominance information (UN) 24 in common.

In transfer data 21 of the second frame, each pixel has luminance information (Y) 25 of the second frame. However, the transfer data 21 of the second frame shown in FIG. 2 does not have chrominance information, which is contained normal image data represented in YUV 4:2:2.

In the image processing method according to the exemplary embodiment, the chrominance information 24 of the transfer data 20 of the first frame is stored as stored chrominance information 22. Then, the luminance information (Y) 25 of the transfer data 21 of the second frame and the stored chrominance information (chrominance information of the first frame) 22 are combined to generate output data 26 of the second frame.

Because the image processing method according to the exemplary embodiment uses the chrominance information of the first frame (the first chrominance information and the second chrominance information) 22 in the second frame, it is possible to reduce the size of the image data.

The visual capacity of human with respect to time is sensitive to brightness (luminance) but relatively insensitive to color (chrominance). With use of this property, the image processing method according to the exemplary embodiment reduces the size of the image data by sharing the chrominance information 24 to which human vision is insensitive in the first frame and the second frame.

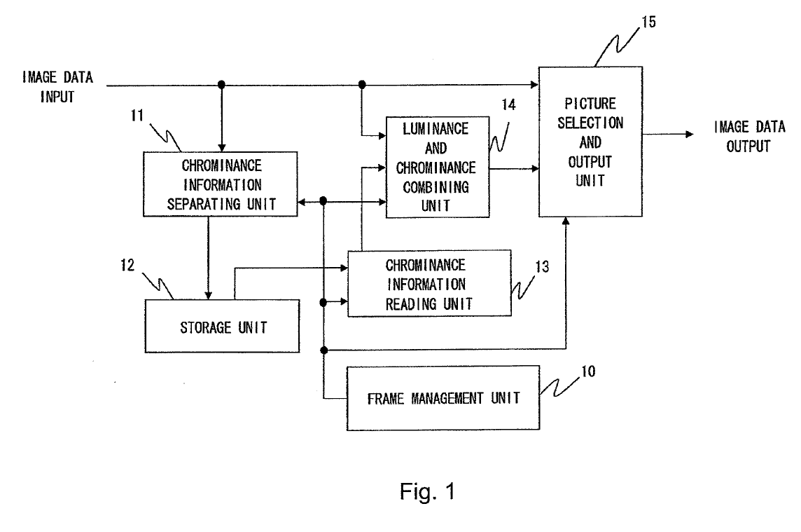

An example of an image processing apparatus for implementing the image processing method according to the exemplary embodiment is described hereinafter with reference to FIG. 1. The image processing apparatus shown in FIG. 1 includes a frame management unit 10, a chrominance information separating unit 11, a storage unit 12, a chrominance information reading unit 13, a luminance and chrominance combining unit 14, and a picture selection and output unit 15.

The frame management unit 10 has a function of determining whether input image data of each frame has chrominance information or not and managing the information. The chrominance information separating unit 11 has a function of separating chrominance information from image data when the input image data has chrominance information. The storage unit 12 has a function of storing the chrominance information separated by the chrominance information separating unit 11.

The chrominance information reading unit 13 has a function of reading the chrominance information stored in the storage unit 12. The luminance and chrominance combining unit 14 has a function of combining luminance information in the input image data (luminance information of the second frame) and the chrominance information read from the storage unit 12 by the chrominance information reading unit 13 (chrominance information of the first frame) and restoring it to data having luminance and chrominance information. The picture selection and output unit 15 selects the input image data or the data from the luminance and chrominance combining unit 14 based on management information from the frame management unit 10 and outputs it as image data.

The operation of the image processing apparatus according to the exemplary embodiment is described hereinafter with reference to FIGS. 1 and 2.

The frame management unit 10 determines whether input image data of each frame has the chrominance information 24. First, when the transfer data 20 of the first frame (which is data containing both luminance information and chrominance information) is input, the frame management unit 10 notifies the chrominance information separating unit 11 and the picture selection and output unit 15 that the input image data is of a frame having the chrominance information.

The chrominance information separating unit 11 then selects the chrominance information 24 from the input transfer data 20 of the first frame and outputs the chrominance information 24 to the storage unit 12. The storage unit 12 stores the chrominance information 24. The chrominance information 24 stored in the storage unit 12 is the stored chrominance information 22. Further, in this case, the picture selection and output unit 15 selects the input transfer data 20 of the first frame as an output.

After image processing of the transfer data 20 of the first frame, the transfer data 21 of the second frame (which is data containing only luminance information) is input. The frame management unit 10 notifies the chrominance information separating unit 11, the chrominance information reading unit 13, the luminance and chrominance combining unit 14 and the picture selection and output unit 15 that the input image data is of a frame not having the chrominance information. In this case, the chrominance information separating unit 11 does not separate chrominance information from the transfer data of the second frame.

The chrominance information reading unit 13 reads the chrominance information of the first frame stored in the storage unit 12 (the stored chrominance information 22) and outputs it to the luminance and chrominance combining unit 14. The luminance and chrominance combining unit 14 combines the luminance information 25 of the input transfer data 21 of the second frame and the chrominance information 24 received from the chrominance information reading unit 13 and forms the output data 26 of the second frame that has luminance and chrominance information. Then, the picture selection and output unit 15 selects the output data 26 of the second frame from the luminance and chrominance combining unit 14 and outputs it as image data.

In the exemplary embodiment of the present invention described above, because the chrominance information (the first chrominance information and the second chrominance information) 24 of the first frame is used in the second frame, it is possible to reduce the size of image data. Therefore, even if the number of frames increases in order to reduce the effect of an afterimage phenomenon, it is possible to suppress an increase in the amount of data handled in a picture device. Further, because an increase in the amount of data is suppressed, it is possible to suppress an increase in memory size, transmission channel band, power consumption and so on.

Note that, in FIG. 2, luminance information is input in all pixels in the first frame 20 and the second frame 21, and all of the chrominance information 24 contained in the first frame 20 are used as the stored chrominance information 22. However, the image processing method according to the exemplary embodiment may be implemented in part of the pixels of the first frame 20 and the second frame 21.

For example, in the case of performing reading of the data of the second frame after performing reading of the data of the first frame stored in a memory device such as a DRAM, image processing according to the exemplary embodiment can be implemented only arbitrary part of pixels constituting each frame.

Further, the ratio of frames having both luminance information and chrominance information and frames having only luminance information can be set arbitrarily. For example, if the ratio of frames having both luminance information and chrominance information and frames having only luminance information is 1:2, the data size can be smaller than that when the ratio is 1:1.

Furthermore, although the case with YUV 4:2:2 format is described by way of illustration as the image processing method according to the exemplary embodiment, the present invention can be equally applied to a case with another format such as YUV 4:4:4 or YUV 4:2:0.

### Second Exemplary Embodiment

An image processing method according to a second exemplary embodiment is described hereinafter. In the image processing method according to the exemplary embodiment, chrominance information is contained in part of transfer data of the second frame. The second exemplary embodiment is the same as the above-described first exemplary embodiment except for that, and the redundant description is omitted.

In the image processing method according to the exemplary embodiment, for a pixel in which there is a large change in chrominance information when comparing the chrominance information of each pixel in the first frame and the corresponding chrominance information of each pixel in the second frame, chrominance information is added to the transfer data of the second frame. In this manner, by adding chrominance information only for a pixel with a large change in chrominance information, it is possible to achieve image processing with higher accuracy and maintain the small size of the transfer data of the second frame.

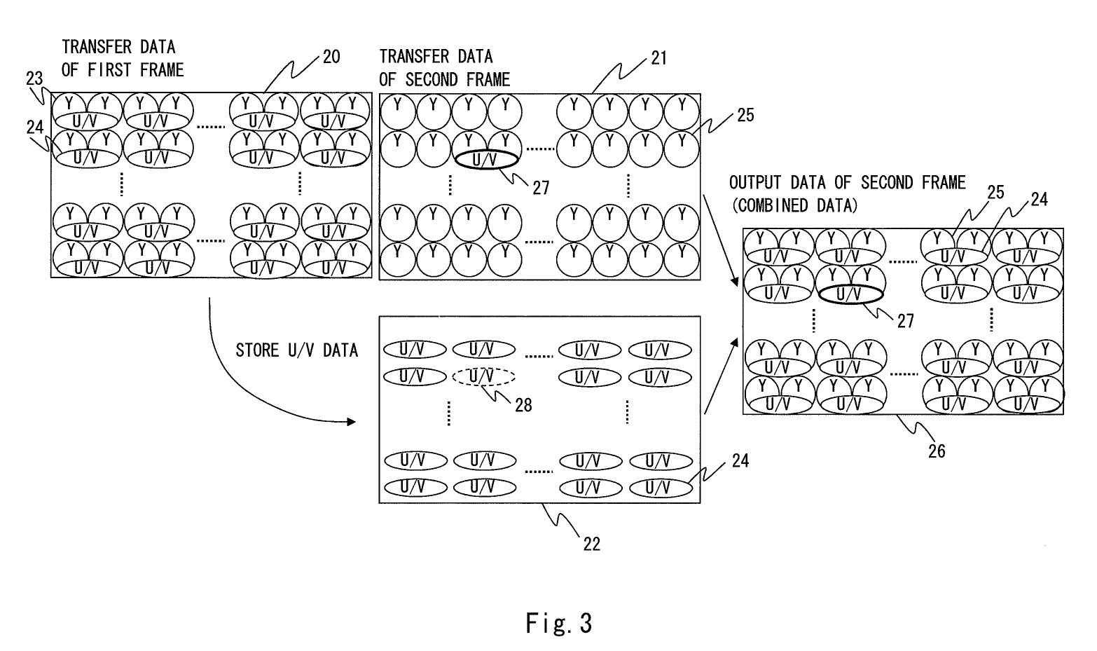

FIG. 3 is a view to describe the image processing method according to the second exemplary embodiment. In the transfer data 21 of the second frame shown in FIG. 3, chrominance information 27 is contained in addition to the luminance information 25. A pixel in which the chrominance information 27 is added is a pixel where there is a relatively large change in chrominance information from the image data of the first frame. Then, the transfer data 21 of the second frame and the stored chrominance information 22 are combined to thereby generate the output data 26 of the second frame. The output data 26 of the second frame is made up of the luminance information 25 of the second frame, the chrominance information 24 of the first frame and the chrominance information 27 of the second frame.

In the stored chrominance information 22, storage of chrominance information 28 in the pixel corresponding to the chrominance information 27 added to the transfer data of the second frame may be omitted. The image processing method according to the exemplary embodiment may be implemented with use of an image processing apparatus in which a means of detecting a change in chrominance information between frames is added to the image processing apparatus described in the first exemplary embodiment, for example.

### Third Exemplary Embodiment

An image processing method according to a third exemplary embodiment is described hereinafter. In the image processing method according to the exemplary embodiment, part of the luminance information contained in the transfer data of the second frame is omitted. The third exemplary embodiment is the same as the above-described first exemplary embodiment except for that, and the redundant description is omitted.

In the image processing method according to the exemplary embodiment, for a pixel in which a change in luminance information is small when comparing the luminance information of each pixel in the first frame and the corresponding luminance information of each pixel in the second frame, luminance information is eliminated from the transfer data of the second frame. By omitting the luminance information in a pixel with a small change in luminance information, it is possible to reduce the size of the transfer data of the second frame.

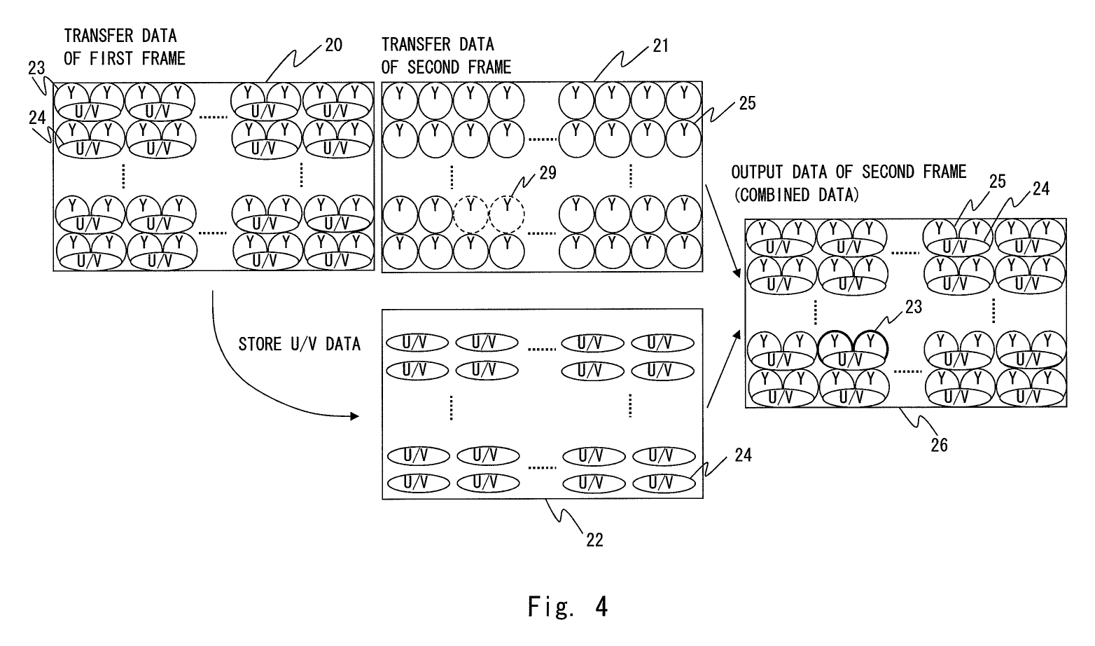

FIG. 4 is a view to describe the image processing method according to the third exemplary embodiment. In the transfer data 21 of the second frame shown in FIG. 4, luminance information 29 indicated by a dotted line is omitted. Further, the given luminance information 23 of the transfer data 20 the first frame in the pixel corresponding to the omitted luminance information 29 is stored in memory or the like. Then, the transfer data 21 of the second frame, the stored chrominance information 22 and the given luminance information of the first frame stored in the memory or the like are combined to thereby generate the output data 26 of the second frame. The output data 26 of the second frame is made up of the luminance information 25 of the second frame, the chrominance information 24 of the first frame and the luminance information 23 of the first frame.

The image processing method according to the exemplary embodiment may be implemented with use of an image processing apparatus in which a means of detecting a change in chrominance information between frames and a means of storing luminance information of the previous frame (first frame) are added to the image processing apparatus described in the first exemplary embodiment, for example.

### Fourth Exemplary Embodiment

An image processing method according to a fourth exemplary embodiment is described hereinafter. In the image processing method according to the exemplary embodiment, chrominance information is contained in part of the transfer data of the second frame, and part of luminance information contained in the transfer data of the second frame is omitted. The fourth exemplary embodiment is the same as the above-described first exemplary embodiment except for that, and the redundant description is omitted.

In the image processing method according to the exemplary embodiment, for a pixel in which a change in chrominance information is large when comparing the chrominance information of each pixel in the first frame and the corresponding chrominance information of each pixel in the second frame, chrominance information is added to the transfer data of the second frame. In this manner, by adding chrominance information only for a pixel with a large change in chrominance information, it is possible to achieve image processing with higher accuracy and maintain the small size of the transfer data of the second frame.

Further, in the image processing method according to the exemplary embodiment, for a pixel in which a change in luminance information is small when comparing the luminance information of each pixel in the first frame and the corresponding luminance information of each pixel in the second frame, luminance information is eliminated from the transfer data of the second frame. By omitting the luminance information in a pixel with a small change in luminance information, it is possible to reduce the size of the transfer data of the second frame.

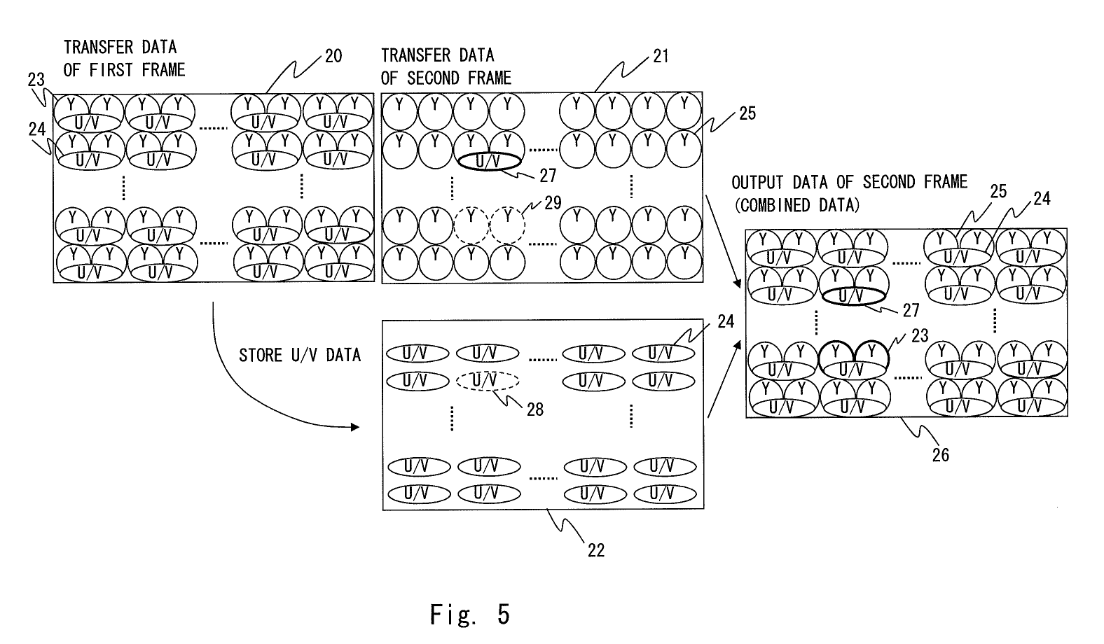

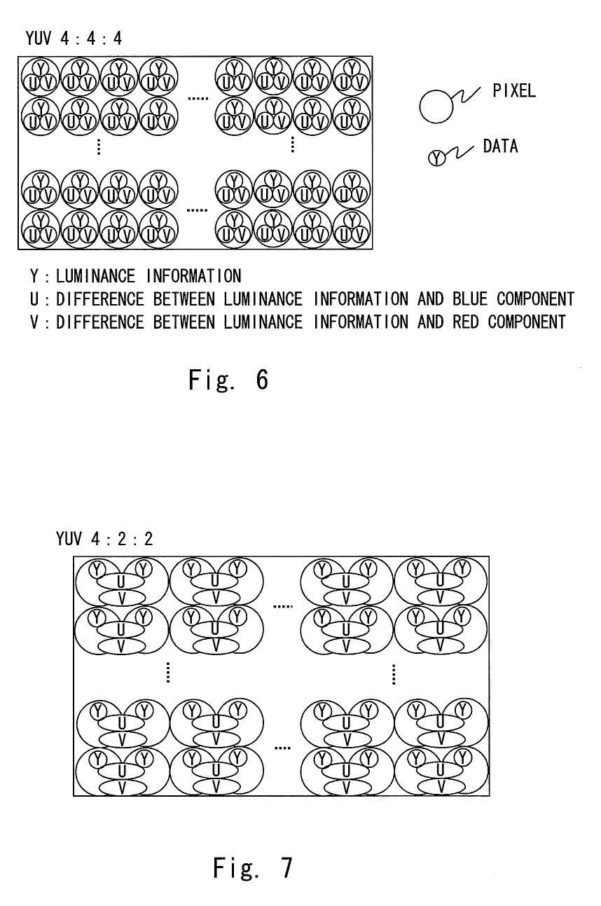

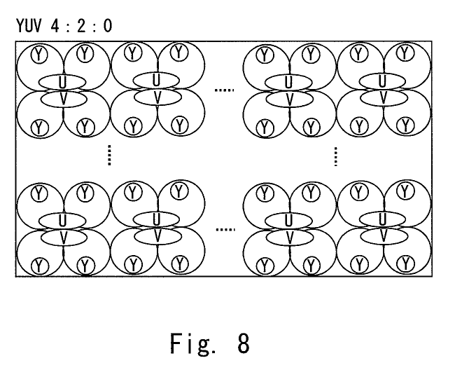

FIG. 5 is a view to describe the image processing method according to the fourth exemplary embodiment. In the transfer data 21 of the second frame shown in FIG. 5, chrominance information 27 is contained in addition to the luminance information 25. A pixel in which the chrominance information 27 is added is a pixel where there is a relatively large change in chrominance information from the image data of the first frame. Further, in the transfer data 21 of the second frame, luminance information 29 indicated by a dotted line is omitted. The given luminance information 23 of the transfer data 20 the first frame in the pixel corresponding to the omitted luminance information 29 is stored in memory or the like. Then, the transfer data 21 of the second frame, the stored chrominance information 22 and the given luminance information of the first frame stored in the memory or the like are combined to thereby generate the output data 26 of the second frame. The output data 26 of the second frame is made up of the luminance information 25 of the second frame, the chrominance information 24 of the first frame, the luminance information 23 of the first frame, and the chrominance information 27 of the second frame.

In the stored chrominance information 22, storage of chrominance information 28 in the pixel corresponding to the chrominance information 27 added to the transfer data of the second frame may be omitted. The image processing method according to the exemplary embodiment may be implemented with use of an image processing apparatus in which a means of detecting a change in luminance information and chrominance information between frames and a means of storing luminance information of the previous frame (first frame) are added to the image processing apparatus described in the first exemplary embodiment, for example.

While the invention has been described in terms of several exemplary embodiments, those skilled in the art will recognize that the invention can be practiced with various modifications within the spirit and scope of the appended claims and the invention is not limited to the examples described above.

Further, the scope of the claims is not limited by the exemplary embodiments described above.

Furthermore, it is noted that, Applicant's intent is to encompass equivalents of all claim elements, even if amended later during prosecution.

What is claimed is:

1. An image processing method comprising:
preparing image data having luminance information and chrominance information including first chrominance information being information of a color difference between a blue component and luminance and second chrominance information being information of a color difference between a red component and the luminance;
outputting the luminance information and the chrominance information in the image data forming a first frame as data forming the first frame; and
outputting the luminance information in the image data forming a second frame subsequent to the first frame and the chrominance information in the image data forming the first frame as data forming the second frame.

2. The image processing method according to claim 1, wherein part of the chrominance information output as the data forming the second frame is chrominance information added to the second frame.

3. The image processing method according to claim 2, wherein the chrominance information added to the second frame is determined based on a comparison result between an image of the first frame and an image of the second frame.

4. The image processing method according to claim 1, wherein part of the luminance information output as the data forming the second frame is the luminance information of the first frame.

5. The image processing method according to claim 4, wherein a pixel where the luminance information of the first frame is used is determined based on a comparison result between an image of the first frame and an image of the second frame.

6. The image processing method according to claim 2, wherein part of the luminance information output as the data forming the second frame is the luminance information of the first frame.

7. An image processing apparatus comprising:
a chrominance information separating unit that separates chrominance information from image data in a first frame having luminance information and chrominance information including first chrominance information being information of a color difference between a blue component and luminance and second chrominance information being information of a color difference between a red component and the luminance;
a storage unit that stores the chrominance information of the first frame separated by the chrominance information separating unit; and
a luminance and chrominance combining unit that combines luminance information of a second frame and the chrominance information of the first frame stored in the storage unit.

8. The image processing apparatus according to claim 7, wherein part of the chrominance information combined in the luminance and chrominance combining unit is chrominance information added to the second frame.

9. The image processing apparatus according to claim 8, wherein
a unit of detecting a change in the chrominance information between the first and second frames is included, and
the chrominance information added to the second frame is determined based on a change in the chrominance information.

10. The image processing apparatus according to claim 7, wherein part of the luminance information combined in the luminance and chrominance combining unit is the luminance information of the first frame.

11. The image processing apparatus according to claim 10, wherein
a unit of detecting a change in the luminance information between the first and second frames is included, and
a pixel where the luminance information of the first frame is used is determined based on a change in the luminance information.

12. The image processing apparatus according to claim 8, wherein part of the luminance information combined in the luminance and chrominance combining unit is the luminance information of the first frame.
